(19) United States
(12) Patent Application Publication
(10) Pub. No.: US 2018/0308006 A1
(43) Pub. Date: Oct. 25, 2018

(54) Method and Apparatus for Dynamic Evolving Cognitive questioning querying architecture iterative problem solving dynamically evolving feedback loop

(71) Applicant: William Atkinson, Orlando, FL (US)

(72) Inventor: William Atkinson, Orlando, FL (US)

(21) Appl. No.: 15/495,674

(22) Filed: Apr. 24, 2017

(51) Int. Cl. G06N 99/00; G06F 17/30

(52) U.S. Cl. CPC G06N 99/005; G06F 17/30457; G06F 17/30395

(57) ABSTRACT

A dynamically evolving cognitive questioning querying architecture system housed in a plurality of digital apparatus as well as a plurality of computing network, and computing network interfaces and based on end user input, cognitive computing, interactive machine learning queries of the end user, and computational creativity is described. A system forms a dynamically evolving automated multistep desired solution query that provides an artificially intelligent cognitive iterative problem solving feedback loop that becomes increasingly artificially intelligent through time through the real time and dynamically evolving as well as simultaneous interaction of object queries and object solutions working in tandem to provide instantiations based on user input, cognitive computing modules, computational creativity modules, interactive machine learning queries of the end user and creates a plan based on the fulfilled dynamic evolving automated solutions to query. The plan includes a first object solution that transforms a first object solution associated with the first fulfilled dynamically evolving automated solution to query into a second object query and also includes a second object solution that transforms the second object solution into a third object query associated with fulfilled dynamic evolving automated solution to query were the first object solution and the second object solution are selected from multiple object solutions driven by successive as well as previous object queries that transforms into multiple object solutions that evolve dynamically in tandem pairs with multiple object queries through time. The system executes the plan, and outputs a value associated with the third object solution driven by previous object queries as well as previous object solutions related to data from end user input, computational creativity modules, cognitive computing modules, interactive machine learning queries of the end-user that derives a fulfilled dynamically evolving automated solution to query final output.

### FIELD OF INVENTION

The present invention relates to the field of Artificial Intelligence, cognitive computing and computational creativity and more specifically, to a computer system housed within and operating within a plurality of devices to provide a real time dynamically evolving automated multistep problem solving feedback loop solutions applied to various enterprises within a wide variety of industries, thereby providing a unified experience that offers ease of use and highly variable functionality and artificially intelligent cognitive iterative problem solving feedback loop capabilities housed and operating within a plurality of devices in a variety of industries and diverse enterprise for the purpose of furthering the commercial application and marketing presentation of cognitive computing and computational creativity in a clearly distinctive way as well as directly to retail consumers, healthcare providers, diverse commercial industries, as well as the application of Dynamic evolving cognitive questioning querying architecture iterative problem solving dynamically evolving feedback loop to a wide as well as diverse group of industries and end-users.

### BACKGROUND

Some retail consumers, healthcare providers, patients, and wide array of diverse enterprises within various and diverse industries may desire greater functionality, interconnectivity, and real time feedback loop problem solving question querying applications backed by artificial intelligence, machine learning, computational creativity and cognitive computing that is the result of a seamless combination of querying architecture merged with and operating within a plurality of devices as well as on the World Wide Web or “in the cloud”, computational creativity modules, cognitive computing modules, interactive machine learning queries of the end users, end user input, and third-party data sources. This seamless combination creates an artificially intelligent cognitive iterative problem solving feedback loop that becomes increasingly artificially intelligent through time through the real time and dynamically evolving architecture that can be applied to problem solving tasks in various enterprises, industries as well as scientific research and serve the primary purpose of the furtherance of the commercial application and marketing presentation of cognitive computing and computational creativity in a clear and distinctive way as well as directly to retail consumers, healthcare providers, diverse commercial industries, as well as the commercial application of Dynamic evolving cognitive questioning querying architecture iterative problem solving dynamically evolving feedback loop to a wide as well as diverse group of industries and end-users. Some variations of this application of this seamless dynamically evolving cognitive question query architecture when applied within mobile devices, tablets, desk top computes and/or web sites as well as plurality of other digital devices offer combination of third-party services, third-party data sources, computational creativity modules, cognitive computing modules, interactive machine learning query of end user as well as end user input to create a dynamically evolving automated multistep desired solution query system along with creating a iterative problem solving feedback loop that becomes increasingly artificially intelligent through time through the real time to insure an end-user's needs may be met by a combination of many services along with a real time dynamically evolving automated multistep problem solving feedback loop solutions applied to various enterprises within a wide variety of industries, thereby providing a unified experience that offers ease of use and highly variable functionality and artificially intelligent cognitive iterative problem solving feedback loop capabilities. Most of the applications of this dynamic evolving automated solutions to query architecture system and services are built with a specific purpose in mind. For example, an enterprise's product manager studies a target audience, formulates a set of use cases, and then works with the dynamic evolving automated cognitive question querying architecture where the system utilizes cognitive modules, computational creativity modules, end user input, third party data sources, and interactive machine learning querying of end users to develop a series of object question queries and objection solution tandem pairs that becomes increasingly artificially intelligent over time so that an engineering group can utilize artificially intelligent cognitive iterative problem solving feedback loop that becomes increasingly artificially intelligent through time through the real time and dynamically evolving architecture that can be applied to problem solving tasks related to the engineering use case in this example and implement a service for the said engineering use case in this example and applied to specified use cases within a wide array and diverse enterprise industries and commercial sectors.

### SUMMARY OF INVENTION

A dynamically evolving cognitive questioning querying architecture system housed in a plurality of digital apparatus as well as a plurality of computing network and computing networking interfaces and based on end-user input, cognitive computing, interactive machine learning queries of the end user, and computational creativity is described.

A system forms a dynamically evolving automated multistep desired solution query that provides an artificially intelligent cognitive iterative problem solving feedback loop that becomes increasingly artificially intelligent through time through the real time and dynamically evolving as well as simultaneous interaction of object queries and object solutions working in tandem to provide instantiations based on user-input, cognitive computing modules, computational creativity modules interactive machine learning queries of the end user and creates a plan based on the fulfilled dynamic evolving automated solutions to query.

The plan includes a first object solution that transforms a first object solution associated with the first fulfilled dynamically evolving automated solution to query into a second object query and also includes a second object solution that transforms the second object solution into a third object query associated with fulfilled dynamic evolving automated solution to query.

The first object solution and the second object solution are selected from multiple object solutions driven by successive as well as previous object queries that transforms into multiple object solutions that evolve dynamically in tandem pairs with multiple object queries through time.

The system executes the plan, and outputs a value associated with the third object solution driven by previous object queries as well as previous object solutions related to data from end-user input, cognitive computing modules, computational creativity modules that derives a fulfilled dynamically evolving automated solution to query final output:

### BRIEF DESCRIPTION OF THE DRAWINGS

FIG. 1A illustrates a linear plan that includes a first object solution that transforms a first object query associated with the intent into a second object solution. The plan further includes a second object solution that transforms the second object query into the third object solution associated with a goal of the intent. The first object solution and the second object are selected from multiple object solutions as well as multiple objection solution and object query tandem pairs. The system executes the plan, and outputs a value associated with the third object solution.

FIG. 1B illustrates a block diagram of an example plan created by a dynamically evolving cognitive questioning querying architecture system based on third-party sources, cognitive computing modules, computational creativity modules, end-user input, and interactive machine learning queries of the end user, under an embodiment;

FIG. 2 illustrates a block diagram of an example dynamically evolving cognitive questioning querying architecture system based on third-party data sources, cognitive computing modules, computational creativity modules, end-user input, and interactive machine learning queries of the end-user, under an embodiment;

FIG. 3 illustrates a block diagram of an example of abstract representation of a small concept action network and an artificial nodal neuron network framework for a dynamically evolving cognitive question query architecture system based on third party data sources, cognitive computing modules, computational creativity modules, end-user input, and interactive machine learning queries of the end user, under an embodiment;

### DETAILED DESCRIPTION OF DRAWINGS

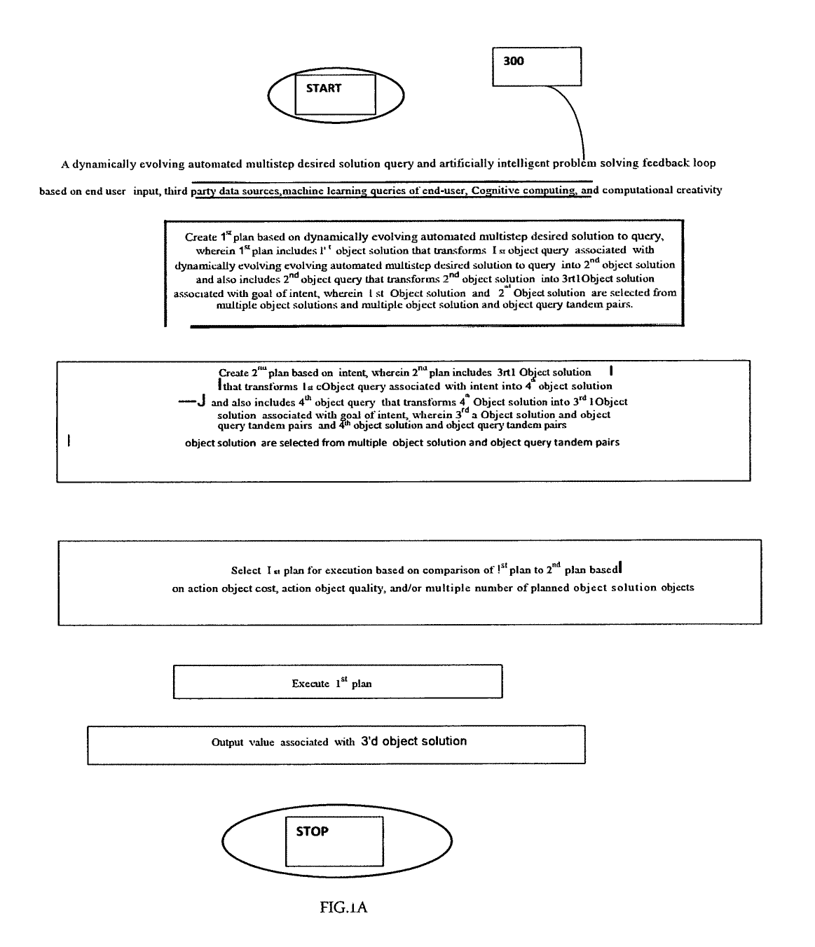

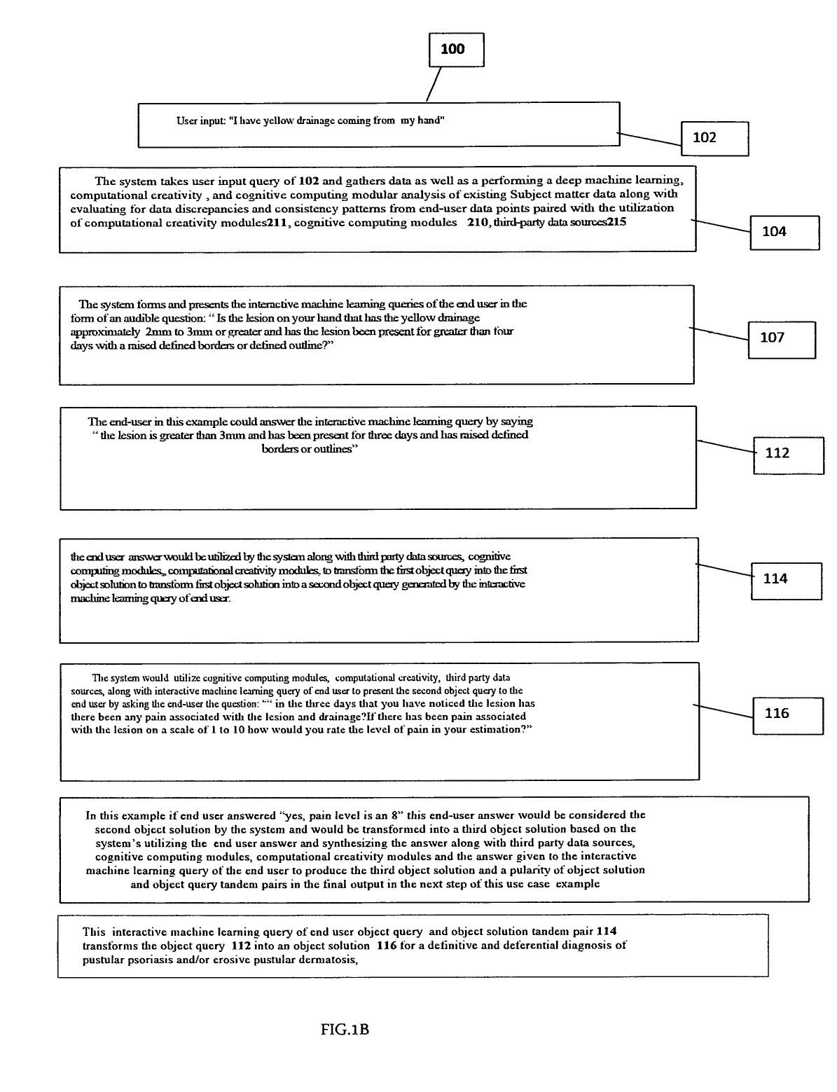

FIG. 1A illustrates Embodiments 300 herein provide dynamically evolving cognitive architecture question querying systems based on third-party data sources, cognitive computing modules, computational creativity modules, end-user input, and interactive machine learning queries of the end-user. At a minimum, the system functions with two object queries and three object solutions. For example, the system forms an intent based on a user-input and creates a plan based on that intent. The plan includes a first object solution that transforms a first object query associated with the intent into a second object solution. The plan further includes a second object solution that transforms the second object query into the third object solution associated with a goal of the intent. The first object solution and the second object are selected from multiple object solutions as well as multiple objection solution and object query tandem pairs. The system executes the plan, and outputs a value associated with the third object solution.

FIG. 1B illustrates a block diagram of an example plan 100 created by a dynamically evolving cognitive questioning querying architecture system based on third-party data sources, cognitive computing modules, computational creativity modules, end-user input, and interactive machine learning queries of the end-user, in which object query are represented by rectangles and object solutions are represented by ovals, under an embodiment.

User input 102 indicates that an end-user inputs “I have had yellow drainage from my hand” to the system. The system forms the intent or the fulfilled dynamically evolving automated solution to query of the user as seeking a differential diagnosis or list of differential diagnosis based on a object query from end-user input into the system in the form of question or object query 104 utilizing natural language modules to form end-user input into the system.

The system takes user input query of 102 and gathers data as well as performing a deep machine learning querying of the end user, computational creativity, and cognitive computing modular analysis of existing Subject matter data along with evaluating for data discrepancies and consistency patterns from end-user data points paired with the utilization of computational creativity modules 211, cognitive computing modules 210, third-party data sources 215 such as APIs, medical journal, past MRI, past CAT scans, activity trackers, personal health narrative, genome marker studies analysis, and from these modules and aggregation of data the system forms an interactive machine learning query of the end-user 107 the system forms and presents the interactive machine learning queries of the end user in the form of an audible question from the system to the end-user that would ask, “Is the lesion on your hand that has the yellow drainage approximately 2 mm to 3 mm or greater and has the lesion been present for greater than four days with a raised defined borders or defined outline?

The end-user in this example could answer the interactive machine learning query by saying “the lesion is greater than 3 mm and has been present for three days and has raised defined borders or outlines” this answer to the interactive machine learning query of the end user would be utilized by the system along with third party data sources, cognitive computing modules, computational creativity modules, to transform the first object query into the first object solution that would be utilized by the system to create a plan based on the end-user's intent or the fulfilled dynamically evolving automated solution to query of the end-user that in this case would be seeking a differential diagnosis or list of differential diagnosis and/or potential plurality of diagnosis. The end-user in this example could answer the interactive machine learning query by saying “the lesion is greater than 3 mm and has been present for three days and has raised defined borders or outlines” this answer to the interactive machine learning query of the end-user would be utilized by the system along with third party data sources, cognitive computing modules, computational creativity modules, to transform the first object query into the first object solution that would be utilized by the system to create a plan based on the end-user's intent or the fulfilled dynamically evolving automated solution to query of the end user as seeking a deferential diagnosis or list of deferential diagnosis and/or potential plurality of diagnosis

Object query 112 for the system based on interactive machine learning queries of the end user in this example would ask an additional interactive machine learning query of the end user, such as “in the three days that you have noticed the lesion has there been any pain associated with the lesion and drainage? If there has been pain associated with the lesion on a scale of 1 to 10 with 10 being the most intense and 1 being the least intense would you rate the level of pain in your estimation?”

In this example if end user answered “yes, pain level is an 8” this interactive machine learning query of the end user object query and object solution tandem pair 114 transforms the object query 112 into an object solution 116 for a definitive and deferential diagnosis of pustular psoriasis and/or erosive pustular dermatosis, based on the end user input, cognitive computing modules both supported and unsupported by code, computational creativity modules both supported and unsupported by code, interactive machine learning queries of the end user that the end user answers, and third party data sources both supported and unsupported by code.

Even though the system has not been intentionally designed to deliver definitive diagnosis and/or deferential diagnosis based solely on end-user input, the system is able to intelligently synthesize a way of creating such diagnosis and/or differential diagnosis based on the system's multiple as well as real time dynamically evolving object query and object solution tandem pairs driven based on end-user input, cognitive computing modules, computational creativity modules, third party data sources, and interactive machine learning queries of the end-user.

Although FIG. 1A illustrates an example of a system creating a single plan with a linear sequence that includes three objet queries and four object solutions, however it should be noted, stated, and reinforced that the system creates a plurality of multiple simultaneous and parallel plans each of which may include any plurality of real time dynamically evolving and spontaneously random combination of linear sequences, splits, joins, and iterative sorting loops, and any number of object query and object solution tandem pairs.

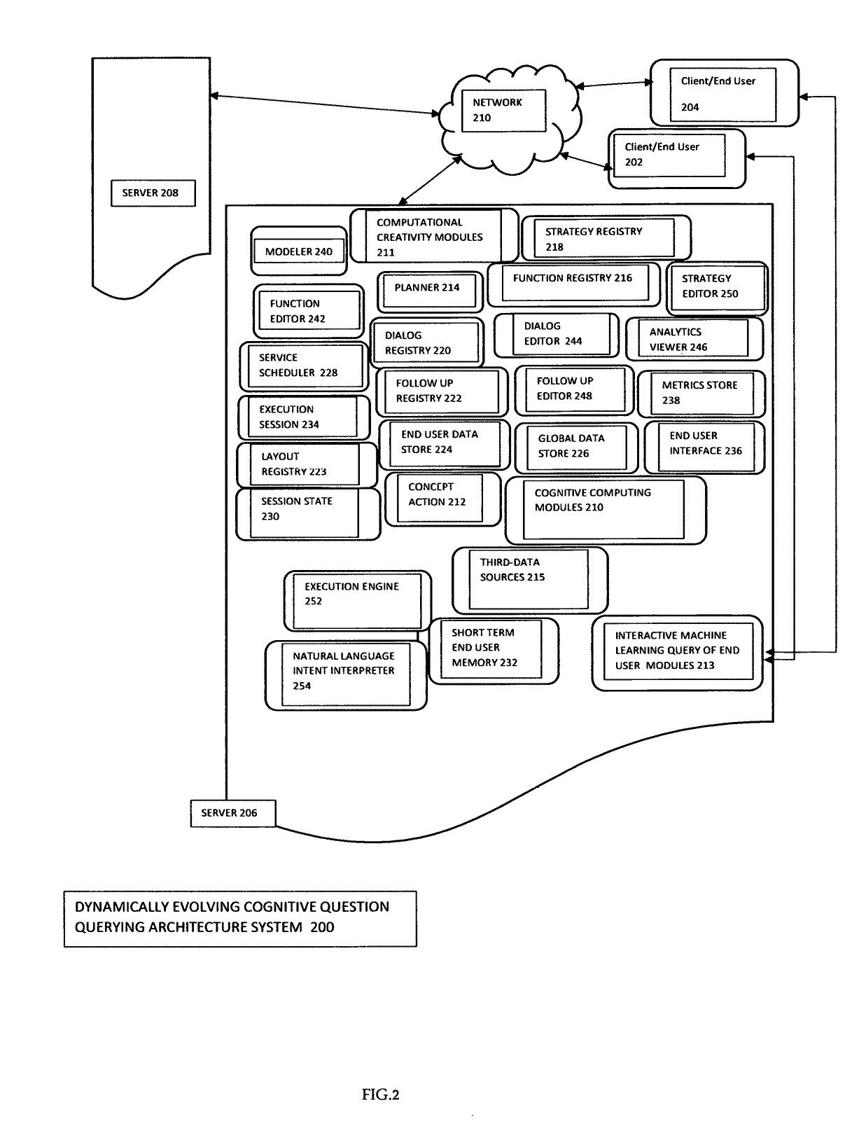

FIG. 2 illustrates a block diagram of a dynamically evolving cognitive questioning querying architecture system based on third-party data sources both supported and unsupported by code, cognitive computing modules both supported an unsupported by code, computational creativity modules both supported and unsupported by code, end-user input, and interactive machine learning queries of the end-user 200, under an embodiment.

As shown in FIG. 2, the system 200 may illustrate a cloud computing environment in which data, applications, services, third party data both supported and unsupported by code as well as other resources are stored and delivered through shared data-centers but the embodiment of the system can also be housed and operate within a plurality of devices such as tablets, smartphones, desk top computers, kiosks, digital personal assistants, and a polarity of other devices but regardless of the device the system appears as a single point of access for the end-users.

The system 200 may also represent any other type of distributed computer network environment in which servers control the storage and distribution of resources and services for different client users.

In an embodiment, the system 200 represents a cloud computing system that includes a first client and/or end-user 202, a second client and/or end-user 204, and a first server 206 and a second server 208 that may be provided by a hosting company.

The clients and/or end-user 202-204 and the servers 206-208 communicate via a network 210 The first server 206 includes components 212-254 in an embodiment.

Although FIG. 2 depicts the system 200 with two clients and/or end-user 202-204, two servers 206-208, and one network 210, the system 200 may include any infinite number of clients of clients and infinite number of end-users 202-204, and number of servers 206-208, and/or any number of networks 210 The clients and/or end-users 202-204 and the servers 206-208.

FIG. 2 depicts the system components 212-254 residing completely on the first server 206, but the system components 212-254 may reside completely on the first server 206, completely on the second server 208, completely on the clients 202-204, completely on another server that is not depicted in FIG. 2, or in any combination partially on the servers 206-208, partially on the clients 202-204, in a polarity of devices that are independent of servers, and partially on the other server.

One of the server components may include a cognitive computing modules either supported or unsupported by code 210 computational creativity modules either supported or unsupported by code 211, third-party data sources 215, interactive machine learning query modules either supported or unsupported by code 213 concept action network 212

The concept action network 212 organizes and facilitates the interoperating execution of Internet enabled services, and may be represented as a mathematical graph and/or analysis with constraints defining the structure.

Third-party data sources either supported or unsupported by code, cognitive computing modules either supported or unsupported by code, computational creativity modules either supported or unsupported by code, interactive machine learning query modules either supported or unsupported by code may interact with the concept action network 212 by extending the concept action network 212 with new concept objects, new object queries, new object solutions, new object solution and object query tandem pairs, and new implemented services as well as executed plans and multistep solution to multistep queries.

End-users may interact with the concept action network 212 to accomplish end user tasks and end-users are asked questions directly from the system or queried by the interactive machine learning query module 213 and based on deep analysis and data synthesis of the cognitive computing modules either supported or unsupported by code 210, the computational creativity modules either supported or unsupported by code 211, third-party data sources either supported or unsupported by code 215.

An internet enabled service is a collection of functional interfaces to data retrievals, such as a local business search or querying a shopping cart, nontrivial computations, such as a computing a symbolic integral, and real world actions, such as booking a reservation for a flight on an airline or turning off the washing machine and/or dryer remotely in a smart enabled home.

These functional interfaces are exposed to the public Internet via well-defined interfaces using standard protocols; when depicted as a mathematical graph, the concept action network 212 consists of nodes and edges.

These nodes in a concept action network 212 include object solution, object queries, concept objects and action objects; a concept object is a model of a real world entity, such as a patient, or coupling thereof, such as an appointment, for the patient and a time an object solution is an action object is a model of an atomic unit of work that declares its external dependencies as input concept objects and produces a predetermined type of output concept object.

The concept action network 212 may catalog similar internet enabled services under a common schema, providing interoperability; the concept action network 212 may be depicted as a well-defined, strongly-typed mathematical graph structure that defines precisely a space of known capabilities.

The server 206 may also included a planner 214 component; when provided with an intent, a planner 214 component; when provided with an intent and/or the fulfilled dynamically evolving automated solution to query of the end-user, a planner 214 produces a static plan of execution, which is a collection of input signals and a goal representing the semantics of an end user's desired task or step.

A plan is a directed and acyclic coupling of concept action network nodes; being directed and acyclic ensures that the plan is executable and that every step in the plan makes progress to the goal.

Plans may include multiple instances of concept action network nodes, computational creativity modules, cognitive computing modules, interactive machine learning query of end-user modules, third party data sources that can work in a polarity of various combinations and configurations for example two distinct businesses in the use care example that included one task includes, as a component, another task of finding the nearest restaurant to the nearest movie theater.

The planner 214 also revises plans when dynamic execution deems necessary and based on real time dynamically evolving evaluation and feedback from computational creativity modules, cognitive computing modules, third party data sources, and interactive machine learning queries of the end user.

The server 206 may include several registry components; a functional registry 216 maps function values to object solutions and object query tandem pairs, action objects that result from object solutions based on cognitive computing modules either supported or unsupported by code, computational creativity modules either supported by code, interactive machine learning queries of the end user, end user input, and third-party data sources either supported or unsupported by code.

Function values bundle declarative metadata about some action implementation with an invokable endpoint; a strategy registry 218 is a registry of selection strategies and instantiation strategies, both of which are used to satisfy the cardinality constraints of action inputs without bothering the end-user.

Strategies are keyed off the execution context in which they apply; a dialog registry 220 is a registry of dialog templates, keyed off the execution context in which they apply and guarded by additional dynamic context triggers.

A follow up registry 222 is a registry of follow up plan intents/goals, used to suggest follow up action to an end-user under specific situation. Entries in the follow up registry 222 are also keyed off the execution context in which they apply and guarded by additional dynamic context triggers.

A layout registry 223 stores third-party data sources either supported or unsupported by code, computational creativity modules either supported or unsupported by code, cognitive computing modules either supported or unsupported by code, end-user input, and interactive machine learning queries of the end user layout descriptions which the system 200 uses for rendering outputs based on object query and object solution tandem pairs, objection solution values to be rendered along with desired automated multistep dynamically evolving solutions to query, such as the example of the deferential diagnosis described in FIG. 1

An end user data store 224 is an end user specific storage of preferences and instrumented usage data, used to store both the raw data about decisions an end user makes and official preferences; a global data store 226 is a cross-user storage of default preferences and aggregate usage data that is updated in batches offline from end user specific data.

A service scheduler 228 determines the order in which services will be called for a particular action invocation; the service scheduler 228 balances the cost and quality of each service to maximize precision and recall.

A session state 230 is the component specific session of execution; a short term end user memory 232 is made up of recently completed plans and currently interrupted plans that are pending additional input as well as pending machine deep learning input and analysis from computational creativity modules and cognitive computing modules.

An execution session 234 is a place for data, which is usually ephemeral, which an execution engine 252 uses; for example, as a plan executes the deferential diagnosis example in FIG. 1B the execution engine 252 stores the intermediate diagnosis classification objection solution values in the execution session 234.

An end user interface 236 is the user's view into the system 200 and associates an end user with an execution session; the end user interface 236 enables the end users intent to be elicited at each step of interaction.

A metrics store 238 is a data store housing all the raw, end user agnostic runtime data, such as service invocation attempts, success, failures, latency, overhead, dialog selection counts and rendering overhead, end user request counts and overhead, and strategy selection counts and overhead, etc. that enable creation and updating of the data supporting the runtime environment.

A modeler 240 creates and updates concepts objections, such as updating primitive and structured types, and action objects, object query and object solution tandem pairs, with updates inclusive of updating input/output/metadata schema definitions.

A function editor 242 creates and updates provider specific implementations of action objects, which may involve writing some code in a sandboxed scripting language that may be partially generated and validated against objection solution and objection query tandem pairs as well as against action objects.

A dialog editor 244 creates and updates dialog scripts that specify output messaging and logic for various aspects of the system 200, which, in an embodiment, likely involves a simple templating language with conditional code, variables, etc.

An analytics viewer 246 provides insight into the data stored in the metrics store and generates reports, which may include things like performance time of various components overtime, domain distribution of end user requests, and speed and performance analytics for service providers, etc.

A follow up editor 248 associates follow up goals with a contextual trigger in which the follow up goals should become active and recommended to an end user.

A follow up trigger may evaluate the execution context that led to the current goal, user preferences, or environmental conditions; all of these components further synthesize data into a strategy editor 250 which writes instantiation and selection strategies in a sandboxed scripting language and registers those strategies with the appropriate context in which they should be triggered.

All of this synthesized data is further analyzed through deep machine learning processes, deep vision processing, natural language processing, computational linguistics, information retrieval, as well as machine learning which is capable of learning at scale, reasoning with purpose, interacting with humans through natural interaction, understanding general human queries and formulating responses in real time and in a spontaneous and dynamically evolving way utilizing the computational creativity modules 211 as well as cognitive computing modules 210 and third party data sources 214.

In an embodiment, the server 206 will include the execution engine 252 that interacts with nearly all components of the dynamically evolving cognitive questioning querying architecture system based on third party data sources, 200 cognitive computing modules 210 computational creativity modules 211 and interactive machine learning queries of the end user 214. For example, the execution engine 252 weaves together the end user intent with the planner 214, strategy registry 218, dialog registry 220, end user data store 224, function registry 226, and session state 230 to set up and complete tasks.

The execution engine 252 also handles interrupted tasks and resumes interruptions when more data is elicited; the execution engine 252 is instrumented, which allows the execution engine 252 to collect dynamic data like end user preferences.

When action object, object solution and object query tandem pair preconditions are not met, the execution engine 252 may dynamically adapt and/or interactively elicit feedback from and end user in order to continue with new information.

The concept action network 212 enables queries and tasks from potentially many input sources to be represented in a single mathematical structure that does not contain natural language or other potentially ambiguous constructs along with allowing objection solution and object query tandem pairs to be represented in the same way.

Below is an example of an unambiguous intent expressed in terms of a concept action network 212.

the execution engine 252 intelligently schedules evaluation of services within the execution order semantics; when parallel or alternative paths exist in an executable plan, the execution engine 252 dynamically determines whether to proceed along one or more paths or whether to prompt for additional end user input before proceeding.

These determinations are made from a variety of sources, including past result precision, data base discrepancies, recall, deep vision, deep vision interactive machine learning pattern recognition, performance, computational creativity modules either supported or unsupported by code, cognitive computing modules either supported or unsupported by code, third party data sources either supported or unsupported by code, cognitive computing modules either supported or unsupported by code, third party data sources either supported or unsupported by code, interactive machine learning query modules either supported or unsupported by code where the system actively queries end-user based on data synthesis as well as machine deep learning modules, global and local user feedback.

A natural language intent interpreter 254 provides a flexible platform for inferring intent structures from natural language queries; the natural language intent interpreter 254 allows the consideration of multiple sources of data, including, but not limited to, modeled vocabulary via exact and approximate language agnostic-matching, implicitly gathered usage data, such as popularity measurement, explicitly annotated training data via machine learning, and contextual data, for example an end users current location; additionally, the natural language intent interpreter 254 is dynamically reactive to both the upstream producers, such as speech recognizers, and downstream consumers, such as planners and executors, of its data.

Furthermore, the natural language intent interpreter 254 is a flexible framework for handling a deep vertical integration between the concept action network 212 and all producers and interpreters of natural language; also, the natural language intent interpreter 254 acts as a conduit through which, for example, a dynamically evolving as well as spontaneously random speech recognizer may access concept action network level usage data or relationships to function more accurately. Similarly, the natural language intent interpreter 254 leverages concept action network level information through its clients, such as the planner 214, a downstream consumer of the natural language intent interpreter 254, to function more quickly and accurately.

The planner 214, in turn, may access internal metadata from either the natural language intent interpreter 254 itself or its upstream producers, such as a speech recognizer.

Speech recognition is facilitated by concept action network specific natural language models, which are in turn bolstered with data generated from concept action network specific planning algorithms along with algorithms generated from computational creativity modules, cognitive computing modules, and also third party data sources, which are tuned and guided by dynamic evolving and spontaneously random execution data.

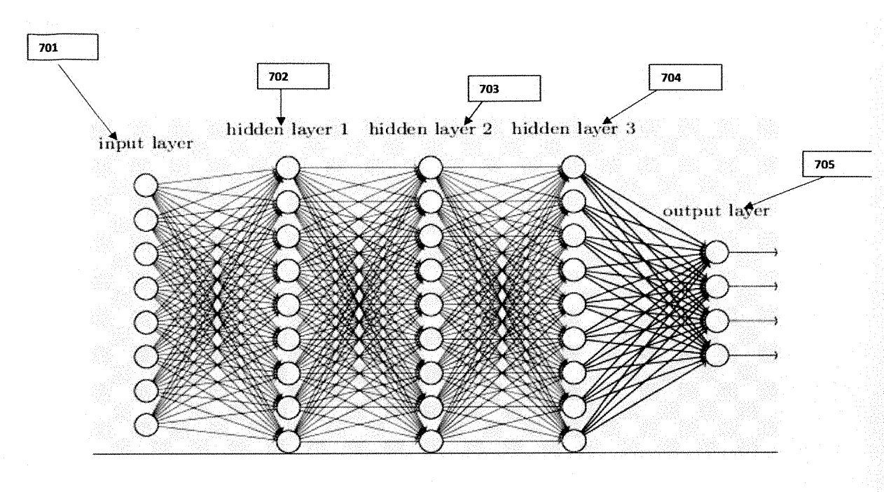

FIG. 3 illustrates a block diagram of an example of abstract representation of a small concept action network for a dynamically evolving cognitive question querying architecture system based on third-party data sources, cognitive computing modules, computational creativity modules, end-user input, and interactive machine learning queries of the end user, under an embodiment.

Although the abstract representation 700 of a small concept action network includes about 300 objects, a real-life concept action network could include thousands or millions into infinite object solution and object query tandem pair combination as well as dynamically evolving and spontaneously random plurality of combinations.

701 represents input layer it is at this layer that it is possible to have a plurality of end user input, third party data sources, as well as interactive machine learning queries of the end user in real-time 702, 703,704 are representative of hidden layers which have a possible infinite polarity as well as dynamically evolving and spontaneously random combination of cognitive computing modules either supported or unsupported by code 210 computational creativity modules either supported or unsupported by code 211 interactive machine learning queries of the end user 213 third party data sources either supported or unsupported by code 705 is representative of output layer which has desired multistep automated dynamic evolving solutions to query as well as polarity of dynamically evolving and spontaneously random object solution outputs that could include thousands or millions into infinite object solutions that have a real time and dynamically evolving relationship the system's real time dynamically evolving automated multistep problem solving feedback loop solutions.

What is claimed is:

1. A dynamically evolving cognitive questioning querying architecture system housed in a plurality of digital apparatus as well as plurality of computing network and computing networking interfaces and based on end user input, cognitive computing modules, third party data sources, interactive machine learning queries of the ender user, and computational creativity modules; forms a dynamically evolving automated multistep desired solution query that provides an artificially intelligent cognitive iterative problem solving feedback loop that becomes increasingly artificially intelligent cognitive iterative problem solving feedback loop that becomes increasingly artificially intelligent through time through the real time dynamically evolving as well as simultaneous interaction of object queries and object solutions working in tandem to provide instantiations based on user input, cognitive computing modules, computational creativity modules, interactive machine learning queries of the end user and creates a plan based on the fulfilled dynamic evolving automated solutions to query as well as simultaneous interaction of object queries and object solutions working in tandem to provide instantiations based on user input, cognitive computing modules, computational creativity modules, third party data sources, interactive machine learning queries of the end user and creates a plan based on the fulfilled dynamic evolving automated solutions query; a system for a dynamically evolving cognitive questing querying architecture based on end user input, cognitive computing, third party data sources, interactive machine learning queries of the end user, and computational creativity, the system and apparatus comprising: one or more processors; a plurality of apparatus hardware storage systems and a non-transitory computer readable medium storing a plurality of instructions, which when executed, cause the one or more processors to: form a plan based on the fulfilled dynamic evolving automated solutions to query based on an end user input, cognitive computing, computational creativity, third party developers and interactive machine learning queries of the end user; create a plan based on the fulfilled dynamic evolving automated solutions to query based on an end user input, cognitive computing modules, computational creativity, third party sources of data and interactive machine learning queries of the end user, wherein the plan comprises a first object solution that transforms a first object query associated with the intent into a second object solution and comprises a second object query that transforms the second object solution into a third object solution. Object associated with a goal of the intent, wherein the first object solution and object query tandem pair and the second object solution and object query tandem pair are selected from a plurality of object solution and object query tandem pairs, and wherein the first object solution and object query tandem pair are provide by a first end user input, first cognitive computing modules, first computational creativity modules, first interactive machine learning queries of the end user, and the second object solution and object query tandem pair are provided by a second third-party data source, a second computational creativity module, a second cognitive computing module, second end user input and second interactive machine learning queries of the end user; execute the plan, and output a value associated with the third object solution and third object query tandem pair.

2. The system of claim 1, where in a dynamically evolving cognitive question querying architecture system housed in and operates on at least one or a group of apparatus selected from the group consisting of:
a telephone
a smartphone
a hologram producing projector
a hologram telephone
a hologram interface
a computing network
a tablet computer
a desk top computer
a kiosk
a consumer electronic device
a music player and plurality of music playing medium
a digital personal assistant
a television
a web service network
a web service parameter
a set-top box; and a plurality of other apparatus that operate the system of claim 1;

3. The system of claim 1, wherein the first object solution and object query tandem pair is provided by a third cognitive computing module, a third computational creativity module, a third end user input, a third interactive machine learning query of end user, and a third third-party data source, the second object solution and object query tandem pair is provided by a fourth cognitive computing module, a fourth computational creativity module, a fourth end user input, a fourth interactive machine learning query of the end user, and a fourth third-party data source, and the third object solution and object query tandem pair is provided by a fifth cognitive computing modules, a fifth computationally creativity module, a fifth end user input, a fifth interactive machine learning query of end user, and a fifth third-party data source;

4. The system of claim 1, wherein the first object query comprises first data which provides instantiations of the first object solution, the second object query comprises second data which provides instantiations of the second object solution, and the third object query comprises third data which provides instantiations of the third object solution.

5. The system of claim 1, wherein an input parameter of the first object query is mapped to a web service parameter and a web service result is mapped to an output value of the first object solution.

6. The system of claim 1, wherein the plan further comprises a third object query that transforms the third object solution to a fourth object solution associated with the goal of a dynamically evolving automated multistep desired solution query that provides an artificially intelligent cognitive iterative problem solving feedback loop that becomes increasingly artificially intelligent through time through the real time and dynamically evolving, and wherein the third object solution is selected from the plurality of independent object solutions.

7. The system of claim 1, wherein the plan further comprises a fourth object solution that transforms the third object query associated with the goal of the intent into a fifth object solution, where in the fourth object solution is selected from the plurality of independent object solutions.

8. The system of claim 1, wherein a fifth object solution is provided by a sixth third-party data source, a sixth cognitive computing module, a sixth computational creativity module, a sixth end user input, and sixth interactive machine learning query of the end user after a plan based on the multistep desired dynamic evolving automated solutions to query is formed based on the user input, cognitive computing modules, computational creativity modules, and interactive machine learning queries of the end user before the value associated with the third object solution and third object query is output.

9. A computer-implemented method for a dynamically evolving cognitive question querying architecture system based on end-user input, computational creativity modules, cognitive computing modules, and interactive third-party data sources, the method comprising: forming an intent based on a user input, computational creativity modules, cognitive computing modules, and interactive third-party sources; creating a plan based on the intent and plan based on the fulfilled dynamic evolving automated desired solutions to query, wherein the plan comprises a first object solution that transforms a first object query associated with the intent into a second object solution and comprises a second object query that transforms the second solution into a third object query associated with a goal of the intent and a dynamically evolving automated multistep desired solution query that provides an artificially intelligent cognitive iterative problem solving feedback loop that becomes increasingly artificially intelligent through time through the real time and dynamically evolving wherein the first object solution and object query tandem pair and the second object solution and object query tandem pair are selected from a plurality of object solution and object query pairs, and wherein the first object solution and object query pair is provided by a first end user input, a first cognitive computing module, a first computational creativity module, a first third-party data source, and a first interactive machine learning query of the end user and a second object solution and second object query pair is provided by a second end user and second interactive machine learning queries of the end user; executing the plan, and outputting a value associated with the third object solution and object query tandem pair; forming based on interactive machine learning queries of the end user;

10. The method of claim 9, wherein the first object solution and object query tandem pair is provided by a third cognitive computing module, third computational creativity module, third end user input, third interactive machine learning query of end user, and third third-party data source, the second object solution and object query tandem pair is provided by a fourth cognitive computing module, a fourth computational creativity module, a fourth end user input, a fourth interactive machine learning query of end user, and a fourth third-party data source, and the third object solution and object query tandem pair is provided by a fifth cognitive computing module, a fifth computational creativity module, a fifth end user, a fifth interactive machine learning query of end user, and a fifth third-party data source;

11. The method of claim 9, wherein the first object query comprises first data which provides instantiations of the first object solution, the second concept object query comprises second data which provides instantiations of the second object solution and the third object query comprises third data which provides instantiations of the third object solution; forming a dynamically evolving automated multistep desired solution query that provides an artificially intelligent cognitive iterative problem solving feedback loop that becomes increasingly artificially intelligent through time through the real time and dynamically evolving based on cognitive computing modules; forming a dynamically evolving automated multistep desired solutions query that provides an artificially intelligent cognitive iterative problem solving loop that becomes increasingly artificially intelligent through time through the real time and dynamically evolving based on computational creativity modules; forming a dynamically evolving automated multistep desired solution query that provides an artificially intelligent cognitive iterative problem solving feedback loop that becomes increasingly artificially intelligent through time through the real time and dynamically evolving based on third-party data sources;

12. The method of claim 9, wherein an input parameter of the first object solution and first object query is mapped to a web service parameter and a web service result is mapped to an output value of the first object solution and first object query.

13. The method of claim 9, wherein the plan further comprises a third object query that transforms the third object solution into a fourth object solution associated with the goal of the intent and a dynamically evolving automated multistep desired solution query that provides an artificially intelligent cognitive iterative problem solving feedback loop that becomes increasingly artificially intelligent through time through the real time and dynamically evolving, and wherein the third action object is selected from the plurality of independent action objects.

14. The method of claim 9, wherein the plan further comprises a fourth object solution that transforms the third object query associated with the goal of the intent into a fifth object solution, wherein the fourth object solution is selected from the plurality of independent object solutions.

15. A computer program, comprising a non-transitory computer-readable medium having a computer-readable program code embodied therein to be executed by one or more processors, the program code including instructions to: form a dynamically evolving automated multistep desired solution query that provides an artificially intelligent cognitive iterative problem solving feedback loop that becomes increasingly artificially intelligent through time through the real time and dynamically evolving based on a user input, cognitive computing modules, computational creativity modules, third party data sources, and interactive machine learning queries of the end user; create a plan based on the intent and a dynamically evolving automated multistep desired solution query that provides an artificially intelligent cognitive iterative problem solving feedback loop that becomes increasingly artificially intelligent through time through the real time and dynamically evolving, wherein the plan comprises a first object solution that transforms a first object solution associated with the intent into a second object query and comprises a second object solution that transforms the second object solution into a third object query associated with a goal of the intent and a dynamically evolving automated multistep desired solution query that provides an artificially intelligent cognitive iterative problem solving feedback loop that becomes increasingly artificially intelligent through time through the real time and dynamically evolving, wherein the first object solution and object query tandem pair and the second object solution and object query tandem pair are selected from a plurality of action object solution and object query tandem pairs, and wherein the first object solution and object query tandem pair is provided by a first third-party sources, a first cognitive computing modules, a first computational creativity modules, end-user input, and interactive machine learning queries of the end user and the second object solution and object query tandem pair is provided by second third-party sources, second cognitive computing modules, second computational creativity modules, second end-user modules, and second interactive machine learning queries of the end user; execute the plan, and output a value associated with the third object solution and object query tandem pair.

16. The computer program product of claim 15, wherein the first object solution and first object query tandem pair is provided by a third third-party source, a third cognitive computing module, a third computational creativity module, third end user input, and a third interactive machine learning query of the end user, the second object solution and object query tandem pair is provided by a fourth third-party data source, a fourth end user input, a fourth cognitive computing modules, a fourth computational creativity module, and a fourth interactive machine learning query of the end user, and the third object solution and object query tandem pair is provided by fifth third-party data sources, fifth computational creativity modules, fifth cognitive computing modules, fifth end user input, and interactive machine learning queries of the end user.

17. The computer program product of claim 15, wherein the first object query comprises first data which provides instantiations of the first object solution, the second object query comprises second data which provides instantiations of the second object solution, and the third object query comprises third data which provides instantiations of the third object solution.

18. The computer program product of claim 15, wherein an input parameter of the first object query is mapped to a web service parameter and a web service result is mapped to an output value of the first object solution.

19. The computer program of claim 15, wherein the plan further comprises a third object solution that transforms the third object query into a fourth object solution associated with the goal of the intent and a dynamically evolving automated multistep desired solution query that provides an artificially intelligent cognitive iterative problem solving feedback loop that becomes increasingly artificially intelligent through time through the real time and dynamically evolving, and wherein the third object solution is selected from the plurality of independent object solutions.

20. The computer program product of claim 15, wherein the plan further comprises a fourth object solution that transforms the third object query associated with the goal of the intent and a dynamically evolving automated multistep desired solution query that provides an artificially intelligent cognitive iterative problem solving feedback loop that becomes increasingly artificially intelligent through time through the real time and dynamically evolving into a fifth object solution, wherein the fourth object solution is selected from the plurality of independent object solutions.

21. The computer program product of claim 15, wherein a fifth object solution and object query tandem pair is provided by sixth third-party data sources, a sixth cognitive computing module, a sixth computational creativity module, a sixth end user input, and a sixth interactive machine learning query of the end user the intent as well as goal of a dynamically evolving automated multistep desired solution query that provides an artificially intelligent cognitive iterative problem solving feedback loop that becomes increasingly artificially intelligent through time through the real time and dynamically evolving is formed based on the user input, computational creativity modules, cognitive computing modules, third party sources, and interactive machine learning queries of the end user before the value associated with the third object solution and object query tandem pairs as output.
